(19) United States
(12) Patent Application Publication
(10) Pub. No.: US 2015/0101562 A1
(43) Pub. Date: Apr. 16, 2015

(54) CDA DEVICE

(71) Applicants: Kia Motors Corporation, Seoul (KR); Hyundai Motor Company, Seoul (KR)

(72) Inventors: Myungsik CHOI, Seoul (KR); Gyu Han Hwang, Yongin-si (KR); Eun Ho Lee, Suwon-si (KR); Yoonsik Woo, Yongin-si (KR); Gee Wook Shin, Ansan-si (KR); Young Hong Kwak, Suwon-si (KR); Won Gyu Kim, Seoul (KR); Wootae Kim, Anyang-si (KR)

(73) Assignees: Kia Motors Corporation, Seoul (KR); Hyundai Motor Company, Seoul (KR)

(21) Appl. No.: 14/139,756

(22) Filed: Dec. 23, 2013

(30) Foreign Application Priority Data
Oct. 16, 2013 (KR) 10-2013-0123299

(51) Int. Cl. F02D 17/02

(52) U.S. Cl. CPC F02D 17/02
USPC 123/198 F

(57) ABSTRACT

A CDA device includes: an outer body that moves up/down in contact with a cam and has an oil input hole at one side and latching pin chambers; an upper seat disposed inside the outer body; an inner body disposed slidably inside the outer body, has a latching pin hole, and is combined with a valve; a lost motion spring that elastically supports the outer body in a lost motion between the inner body and the outer body; latching pins that are slidably disposed in the latching pin chambers and inserted in the latching pin holes; and latching pin springs that push the latching pins into the latching pin hole, in which hydraulic pressure selectively transmitted from the oil input hole pushes the latching pins and the latching pins are separated from the latching pin holes.

### CROSS-REFERENCE TO RELATED APPLICATION

The present application claims priority of Korean Patent Application Number 10-2013-0123299 filed Oct. 16, 2013, the entire contents of which application is incorporated herein for all purposes by this reference.

### BACKGROUND OF INVENTION

1. Field of Invention

The present invention relates to a CDA device. More particularly, the present invention relates to a CDA device having a simple configuration and improved starting performance of an engine.

2. Description of Related Art

In general, internal combustion engines generate power by receiving and burning air and fuel in a combustion chamber. When air is sucked, an intake valve is operated by a camshaft and air is sucked into the combustion chamber while the intake valve is open. Further, an exhaust valve is operated by the camshaft, and air is discharged from the combustion chamber while the exhaust valve is open.

The optimum operation of the intake valve/exhaust valve, however, depends on the RPM of the engine. That is, the appropriate time for lifting or opening/closing the valves depends on the RPM of the engine. In order to implement an appropriate valve operation in accordance with the RPM of the engine, as described above, a Variable Valve Lift (VVL) apparatus that has a plurality of shapes of cams operating valves or operates valves at different lifts in accordance with the RPM of an engine has been studied.

In a similar conception to the VVL apparatus, there is a CDA device. In general, cylinder de-activation (hereafter, referred to as CDA), that is, CDA device means a technology of deactivating some of whole cylinders in braking or driving at a predetermined speed, and during CDA, fuel supply to the cylinders to be activated is stopped and their intake/exhaust valves are stopped.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention have been made in an effort to provide a CDA device having a simple configuration and improved starting performance of an engine.

Various aspects of the present invention provide for a CDA device, including: an outer body that moves up/down in contact with a cam and has an oil input hole at one side and latching pin chambers; an upper seat that is disposed inside the outer body; an inner body that is disposed slidably inside the outer body, has a latching pin hole, and is combined with a valve; a lost motion spring that elastically supports the outer body in a lost motion between the inner body and the outer body; latching pins that are slidably disposed in the latching pin chambers and inserted in the latching pin holes; and latching pin springs that push the latching pins into the latching pin hole, in which hydraulic pressure selectively transmitted from the oil input hole may push the latching pins and the latching pins may be separated from the latching pin holes.

An input channel connecting the oil input hole and the latching pin chamber may be formed between the outer body and the upper seat.

The latching pin may have a latching pin body and a latching pin head larger in diameter than the latching pin body, the latching pin body may connect the outer body and the inner body by being inserted in the latching pin hole of the inner body, and the latching pin body may be selectively separated from the latching pin hole.

The latching pin chamber may include a first chamber where the latching pin head is inserted, a second chamber where the latching pin body is inserted, and a third chamber stepped between the first chamber and the second chamber, and the hydraulic pressure may be selectively transmitted to the third chamber.

The CDA device may further include a retainer combined with the inner body, in which the lost motion spring may be disposed between the upper seat and the retainer.

An anti-rotation hole may be formed in the outer body and the CDA device may further include an anti-rotation pin inserted in the anti-rotation hole and preventing rotation of the outer body.

The CDA device may further include latching caps disposed in the latching pin chambers and supporting the latching pin springs.

Various aspects of the present invention provide for a CDA device, including: an outer body that moves up/down in contact with a cam and has an oil input hole at one side and two latching pin chambers; an upper seat that is disposed inside the outer body; an inner body that is disposed slidably inside the outer body, has a latching pin hole, and is combined with a valve; and two latching pins that are slidably disposed in the latching pin chambers and inserted in the latching pin holes, respectively, in which hydraulic pressure selectively transmitted from the oil input hole may push the latching pins and the latching pins may be separated from the latching pin holes.

The CDA device may further include: a lost motion spring that elastically supports the outer body in a lost motion between the inner body and the outer body; and latching pin springs disposed in the latching pin chambers, respectively, to push the latching pins into the latching pin holes.

An input channel connecting the oil input hole and the latching pin chamber may be formed in at least any one of the outer body and the upper seat.

The latching pins each may have a latching pin body and a latching pin head larger in diameter than the latching pin body, the latching pin body may connect the outer body and the inner body by being inserted in the latching pin hole of the inner body, and the latching pin body may be selectively separated from the latching pin hole.

The latching pin chambers each may include a first chamber where the latching pin head is inserted, a second chamber where the latching pin body is inserted, and a third chamber stepped between the first chamber and the second chamber, and the hydraulic pressure may be selectively transmitted to the third chamber.

The CDA device may further include latching caps disposed in the latching pin chambers and supporting the latching pin springs.

According to various aspects of the present invention, it is possible to simplify the entire configuration and reduce the number of parts, such that it is possible to reduce the production cost and ensure starting performance even without hydraulic pressure applied in starting of an engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are perspective views illustrating an exemplary CDA device according to the present invention.

FIG. 3 is a cross-sectional view taken along line of FIG. 1 and illustrating the operation in a normal mode of the CDA device according to the present invention.

FIG. 4 is a cross-sectional view taken along line of FIG. 1 and illustrating the operation in a CDA mode of the CDA device according to the present invention.

FIG. 5 is a partial enlarged view of the part A in FIG. 3.

FIG. 6 is a view illustrating the parts of an exemplary CDA device according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Like reference numerals are given to like components throughout the specification.

In the drawings, the thickness of layers, films, panels, regions, etc., are exaggerated for clarity.

The case in which it is represented that each part such as a layer, a film, an area, a plate, or the like, is “on” another part is intended to include not only the case in which each part is “directly on”, but also the case in which the other part is between each part and another part.

In contrast, when an element is referred to as being “directly on” another element, there are no intervening elements present.

Throughout the specification, unless explicitly described to the contrary, the word “comprise” and variations such as “comprises” or “comprising”, will be understood to imply the inclusion of stated elements but not the exclusion of any other elements.

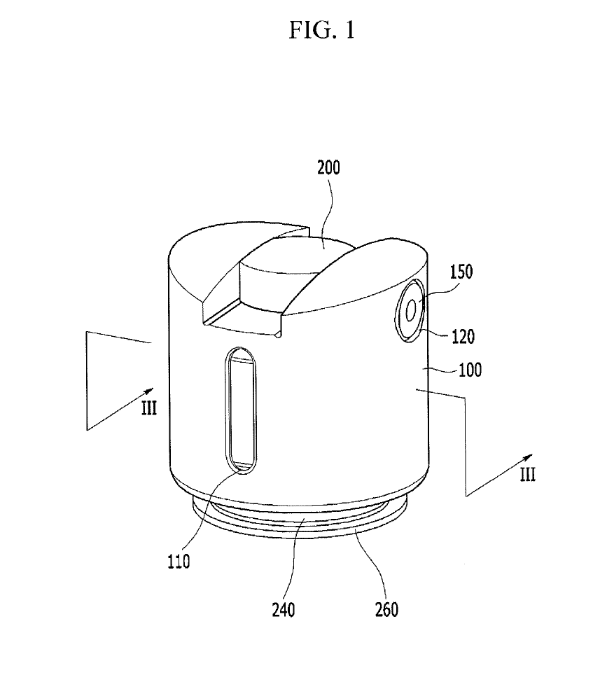

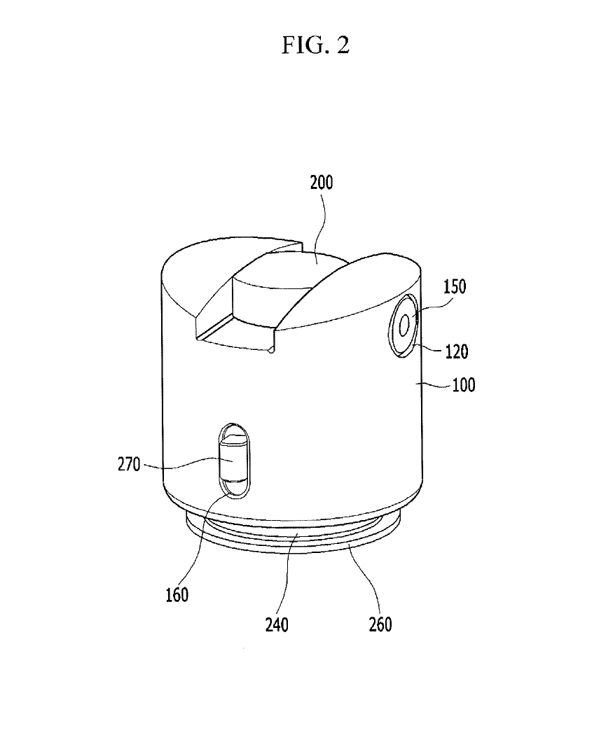

FIGS. 1 and 2 are perspective views illustrating a CDA device according to various embodiments of the present invention.

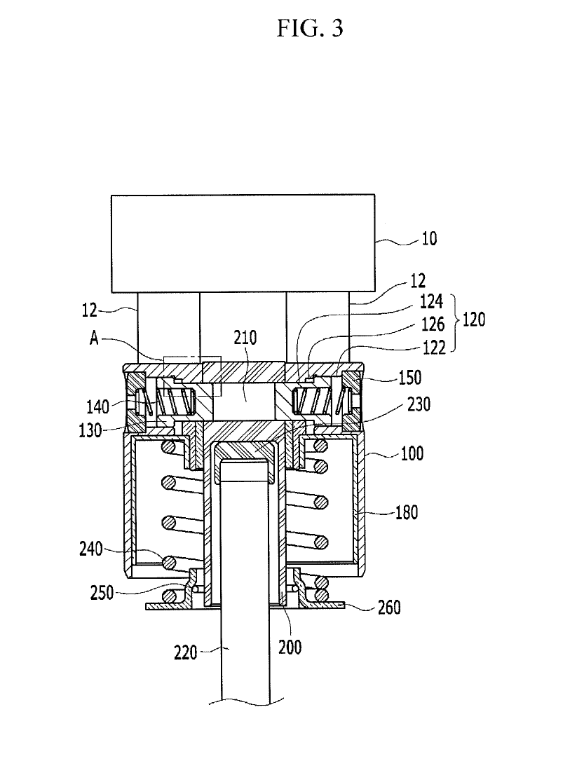

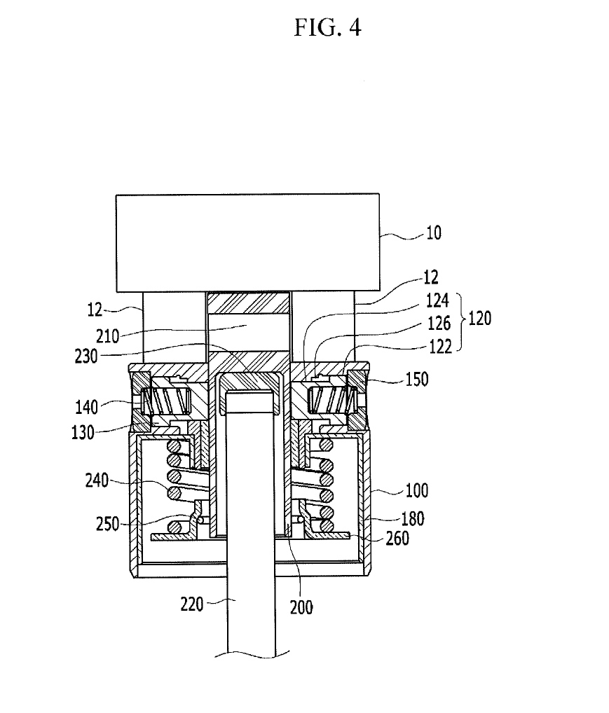

FIG. 3 is a cross-sectional view taken along line of FIG. 1 and illustrating the operation in a normal mode of the CDA device according to various embodiments of the present invention and FIG. 4 is a cross-sectional view taken along line of FIG. 1 and illustrating the operation in a CDA mode of the CDA device according to various embodiments of the present invention.

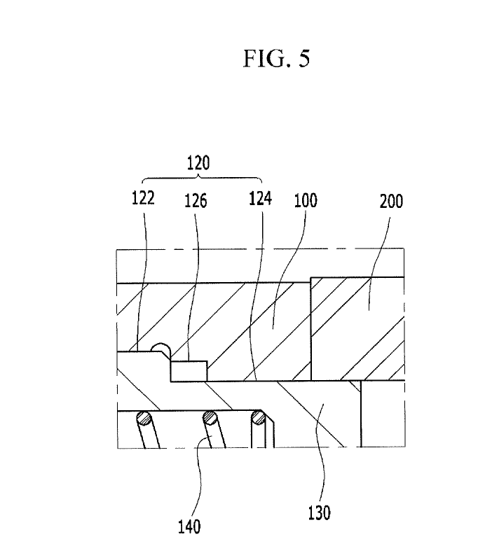

FIG. 5 is a partial enlarged view of the part A in FIG. 3.

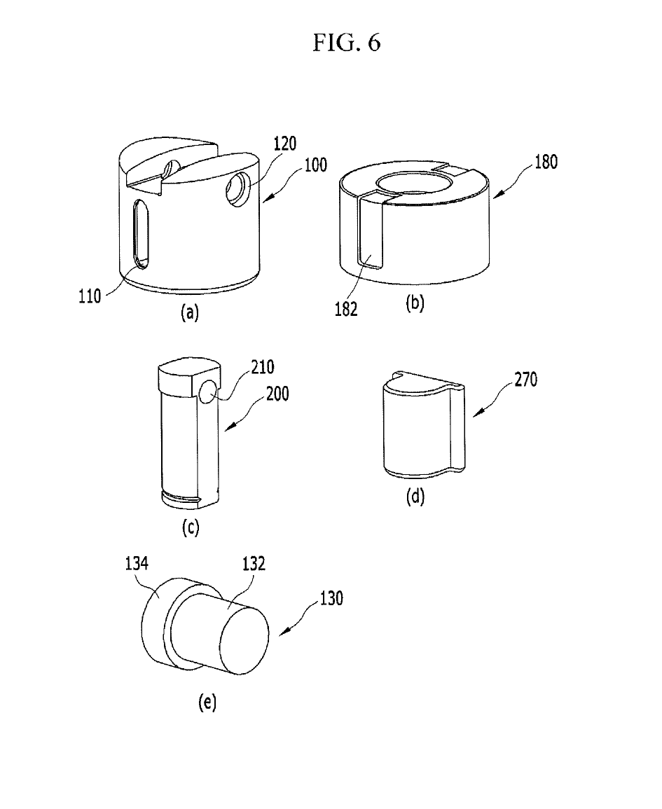

FIG. 6 is a view showing the parts in the CDA device according to various embodiments of the present invention.

Referring to FIGS. 1 to 6, a CDA device according to various embodiments of the present invention includes: an outer body 100 that moves up/down in contact with a cam 12 and has an oil input hole 110 at one side and latching pin chambers 120; an upper seat 180 that is disposed inside the outer body 100; an inner body 200 that is disposed slidably inside the outer body 100, has a latching pin hole 210, and is combined with a valve 220; a lost motion spring 240 that elastically supports the outer body 100 in a lost motion between the inner body 200 and the outer body 100; latching pins 130; and latching pin springs 140 that push the latching pins 130 into the latching pin hole 210.

The latching pin 130 has a latching pin body 132 and a latching pin head 134 larger in diameter than the latching pin body 132, the outer body 100 and the inner body 200 are connected when the latching pin body 132 is inserted in the latching pin hole 210 of the inner body 200, and the latching pin body 132 is selectively separated from the latching pin hole 210.

Input channels 182 connecting the oil input hole 110 and the latching pin chambers 120 are formed between the outer body 100 and the upper seat 180 and the hydraulic pressure selectively transmitted from the oil input hole 110 pushes the latching pin head 134, such that the latching pin 130 may be separated from the latching pin hole 210.

Although the input channels 182 are formed in the upper seat 180 in the drawings, the present invention is not limited thereto and the input channels 182 may be formed in at least any one of the outer body 100 and the upper seat 180.

The latching pin chamber 120 includes a first chamber 122 where the latching pin head 134 is inserted, a second chamber 124 where the latching pin body 132 is inserted, and a third chamber 126 stepped between the first chamber 122 and the second chamber 124, such that the hydraulic pressure may be selectively transmitted to the third chamber 126.

The CDA device further includes retainer 260 combined with the inner body 200 and the lost motion spring 240 may be disposed between the upper seat 180 and the retainer 260. The retainer 260 is fixed to the inner body 200 by a stop ring 250.

An anti-rotation hole 160 is formed at the outer body 100 and the CDA device may further include an anti-rotation pin 270 that is inserted in the anti-rotation hole 160 and prevents rotation of the outer body 100.

The CDA device may further include latching caps 150 disposed in the latching pin chambers 120 and supporting the latching pin springs 140.

As illustrated in the drawings, although there are two latching pin chambers 120 and two latching pins 130 and the latching pins 130 are inserted in the latching pin hole 210 in the drawings, the present invention is not limited thereto and one, or three or more latching pin chambers 120 and latching pins 130 may be provided.

The operation of the CDA device according to various embodiments of the present invention will be described hereafter with reference to the drawings.

In operation of a common engine, the latching pin 130 is kept in the latching pin holes 210 by the elastic force of the latching pin spring 140.

Then, as illustrated in FIG. 3, the cam 12 presses the outer body 100 with rotation of the camshaft 10 and the inner body 200 connected with the outer body by the latching pins 130 opens/closes the valve 220 while reciprocating up/down.

The valve 220 is connected with the inner body 200 by a shim, such that the tolerance generated in manufacturing can be adjusted.

Referring to FIG. 4, when an Engine Control Unit (ECU) controls the CDA device for deactivation, hydraulic pressure from an oil pump is transmitted to the oil input hole 110 through an oil control valve and a cylinder head, which are not illustrated in the figure.

The hydraulic pressure is transmitted to the third chamber 126 through the input channel 182 and pushes the latching pin head 134 and the latching pin 130 is separated from the latching pin hole 210, such that the CDA device implements a CDA mode. Since the third chamber 126 is stepped between the first chamber 122 and the second chamber 124, oil is supplied well, and accordingly, responsibility of the CDA device is ensured.

In this configuration, a specific channel is not formed, but the input channel 182 is formed in the space between the outer body 100 and the upper seat 180, such that the manufacturing process can be simplified and the production cost can be reduced.

In the CDA mode, even through the cam 12 presses the outer body 100 with the rotation of the camshaft 10, the outer body and the inner body 200 are separated, and thus the valve 220 is not opened/closed.

According to the CDA device of various embodiments of the present invention, it is possible to simplify the entire configuration and reduce the number of parts, such that it is possible to decrease the production cost.

Further, the starting performance can be ensured even without hydraulic pressure applied in starting of an engine, and the latching pins 130 are inserted into the latching pin holes 210 when hydraulic pressure is not applied, such that the engine can be normally started.

For convenience in explanation and accurate definition in the appended claims, the terms upper and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A CDA device comprising:
an outer body driven by a cam to move up and down, the outer body including an oil input hole at one side and latching pin chambers;
an upper seat disposed inside the outer body;
an inner body slidably disposed inside the outer body, including a latching pin hole, the inner body operably driving a valve;
a lost motion spring that elastically supports the outer body for lost motion between the inner body and the outer body;
latching pins slidably disposed in the latching pin chambers and selectively inserted in the latching pin holes; and
latching pin springs that push the latching pins into the latching pin hole;
wherein hydraulic pressure selectively transmitted through the oil input hole pushes the latching pins and the latching pins are separated from the latching pin holes.

2. The CDA device of claim 1, wherein an input channel connecting the oil input hole and the latching pin chamber is formed between the outer body and the upper seat.

3. The CDA device of claim 1, wherein the latching pin has a latching pin body and a latching pin head larger in diameter than the latching pin body, and the latching pin body connects the outer body and the inner body by being inserted in the latching pin hole of the inner body and the latching body is selectively separated from the latching pin hole.

4. The CDA device of claim 3, wherein the latching pin chamber includes a first chamber where the latching pin head is inserted, a second chamber where the latching pin body is inserted, and a third chamber stepped between the first chamber and the second chamber, and the hydraulic pressure is selectively transmitted to the third chamber.

5. The CDA device of claim 1, further comprising:
a retainer combined with the inner body;
wherein the lost motion spring is disposed between the upper seat and the retainer.

6. The CDA device of claim 1, wherein an anti-rotation hole is formed in the outer body, and the CDA further includes an anti-rotation pin inserted in the anti-rotation hole and preventing rotation of the outer body.

7. The CDA device of claim 1, further comprising:
latching caps disposed in the latching pin chambers and supporting the latching pin springs.

8. A CDA device comprising:
an outer body driven by a cam to move up and down, the outer body including an oil input hole at one side and two latching pin chambers;
an upper seat disposed inside the outer body;
an inner body slidably disposed inside the outer body including a latching pin hole, the inner body operably driving a valve; and
two latching pins slidably disposed in the latching pin chambers and inserted in the latching pin holes, respectively;
wherein hydraulic pressure selectively transmitted through the oil input hole pushes the latching pins and the latching pins are separated from the latching pin holes.

9. The CDA device of claim 8, further comprising:
a lost motion spring that elastically supports the outer body in a lost motion between the inner body and the outer body; and
latching pin springs disposed in the latching pin chambers, respectively, to push the latching pins into the latching pin holes.

10. The CDA device of claim 8, wherein an input channel connecting the oil input hole and the latching pin chamber is formed in at least any one of the outer body and the upper seat.

11. The CDA device of claim 8, wherein the latching pins each have a latching pin body and a latching pin head larger in diameter than the latching pin body, and the latching pin body connects the outer body and the inner body by being inserted in the latching pin hole of the inner body and the latching body is selectively separated from the latching pin hole.

12. The CDA device of claim 11, wherein the latching pin chambers
each include a first chamber where the latching pin head is inserted, a second chamber where the latching pin body is inserted, and a third chamber stepped between the first chamber and the second chamber, and the hydraulic pressure is selectively transmitted to the third chamber.

13. The CDA device of claim 8, further comprising:
latching caps disposed in the latching pin chambers and supporting the latching pin springs.
